(19) United States
(12) Patent Application Publication
(10) Pub. No.: US 2026/0018002 A1
(43) Pub. Date: Jan. 15, 2026

(54) SYSTEMS AND METHODS FOR BIOMETRIC ACCESS CONTROL OF WELL SITE OPERATIONS

(71) Applicant: SAUDI ARABIAN OIL COMPANY, Dhahran (SA)

(72) Inventors: Ammal F. Al-Anazi, Dammam (SA); Muhammad Daanyal, Ras Tanura (SA)

(73) Assignee: SAUDI ARABIAN OIL COMPANY, Dhahran (SA)

(21) Appl. No.: 18/769,610

(22) Filed: Jul. 11, 2024

(51) Int. Cl. G07C 9/37; E21B 34/06; G06V 40/70; G07C 9/38; G08B 25/01

(52) U.S. Cl. CPC G07C 9/37; E21B 34/066; G06V 40/70; G08B 25/016; G07C 9/38

(57) ABSTRACT

Described is a method for biometric access control at a well site. Biometric data is obtained with a first type of biometric sensor associated with a first biometric access point at the well site. The biometric data is evaluated, and in response to authenticating a user at the first biometric access point, the user is permitted access to a second biometric access point at the well site. Biometric data is obtained with a second type of biometric sensor associated with a second biometric access point that controls access to an operation component at the well site. The biometric data is evaluated, and in response to authenticating the user at the second biometric access point, the user is permitted operational access to the operational component at the well site. The operational component is then adjusted. In response to the adjusting, one or more well parameters at the well site is varied.

### BACKGROUND

The oil and gas sectors, particularly within offshore platforms and onshore well sites, represent a critical need for bolstered safety and security measures. Traditional access control mechanisms, such as physical keys and cards, fall short due to their susceptibility to being lost, stolen, or duplicated. Moreover, these methods lack the sophistication required to effectively deter unauthorized entry, vandalism, and/or misuse of infrastructure. Furthermore, simple password systems for access control are lacking because passwords can be shared or guessed.

Traditional access control systems often lack the capability for real-time, remote monitoring, making it difficult to respond quickly to security breaches or operational issues. In addition, many older systems cannot seamlessly integrate with other security or operational technologies, limiting their effectiveness in providing a comprehensive security solution. Without integrated real-time monitoring, managing access and responding to incidents may be slow and inefficient.

A current need exists for a system for controlling access to well site operations that not only strengthens the security but also cooperates seamlessly with existing operational and security frameworks to support remote, real-time monitoring.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for biometric access control at a well site. A first set of biometric data is obtained with a first biometric sensor associated with a first biometric access point at the well site. The first set of biometric data is evaluated, and in response to authenticating a user at the first biometric access point, the user is permitted access to a second biometric access point at the well site. A second set of biometric data is obtained with a second biometric sensor associated with the second biometric access point that controls access to at least one operational component at the well site. In response to authentication of the user at the second biometric access point, the user is permitted operational access to the at least one operational component at the well site. The at least one operational component is adjusted, and one or more well parameters at the well site are varied in response to the adjusting.

In another aspect, authenticating the user at the first biometric access point includes capturing an image of the user and determining whether the image correlates with a stored image of an authenticated user.

In another aspect, authenticating the user at the second biometric access point includes obtaining an image of a pattern of finger veins of the user and determining whether the pattern of finger veins correlates with a pattern of finger veins in a stored image of an authenticated user.

In another aspect, providing access to the second biometric access point includes causing an access door to unlock.

In another aspect, security personnel is informed in response to the user not being authenticated at the first biometric access point.

In another aspect, security personnel is informed and an alarm is generated in response to the user not being authenticated at the second biometric access point.

In another aspect, providing operational access to the at least one operational component includes electronically controlling a mechanical actuator connected with the at least one operational component.

In another aspect, the at least one operational component is a well valve, and the method includes opening or closing the well valve via the mechanical actuator.

In one aspect, embodiments disclosed herein relate to a system for biometric access control at a well site. The system includes a first biometric sensor configured for obtaining a first set of biometric data from a user. The first biometric sensor is associated with a first biometric access point at the well site and controls access to a second biometric access point at the well site. A second biometric sensor is configured for obtaining a second set of biometric data from the user. The second biometric sensor is associated with the second biometric access point and controls access to at least one operational component at the well site. A mechanical actuator is connected with the at least one operational component at the well site and is configured for adjusting the at least one operational component to vary one or more well parameters at the well site.

In another aspect, the system includes a remote terminal unit and a supervisory control and data acquisition unit configured for wirelessly controlling the mechanical actuator in response to the user being authenticated at the second biometric access point.

In another aspect, the first biometric sensor is a camera, and the second biometric sensor is a fingerprint recognition sensor.

In another aspect, the first biometric sensor is a camera, and the second biometric sensor is a finger vein recognition sensor.

In another aspect, the second biometric sensor is disposed directly on the at least one operational component.

In another aspect, the at least one operational component is a well valve.

In another aspect, the well valve is a master valve, a wing valve, a crown valve, or a choke valve.

In another aspect, the first biometric sensor is disposed on a door, and the second biometric sensor is disposed on a handle of the well valve.

In another aspect, an emergency shutdown unit is integrated with at least one of a surveillance camera, a door lock, and an alarm via the remote terminal unit.

In another aspect, the finger vein recognition sensor comprises a near-infrared light-emitting diode and a monochrome charge-coupled device camera.

In another aspect, the first biometric sensor and the second biometric sensor are different types of biometric sensors configured to collect different types of biometric data.

In another aspect, the first biometric sensor and the second biometric sensor are integrated with a supervisory control and data acquisition unit at the well site to facilitate real-time monitoring of the first and second biometric access points and direct, real-time data transmission to personnel.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 is an illustration of a system for biometric access according to one or more embodiments of the present disclosure.

FIG. 2 is a flowchart illustrating an embodiment of a method for biometric access control according to one or more embodiments of the present disclosure.

FIG. 3 is a flow diagram illustrating an embodiment of a method for biometric access control according to one or more embodiments of the present disclosure.

FIG. 4 is an illustration of a computing system in accordance with one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

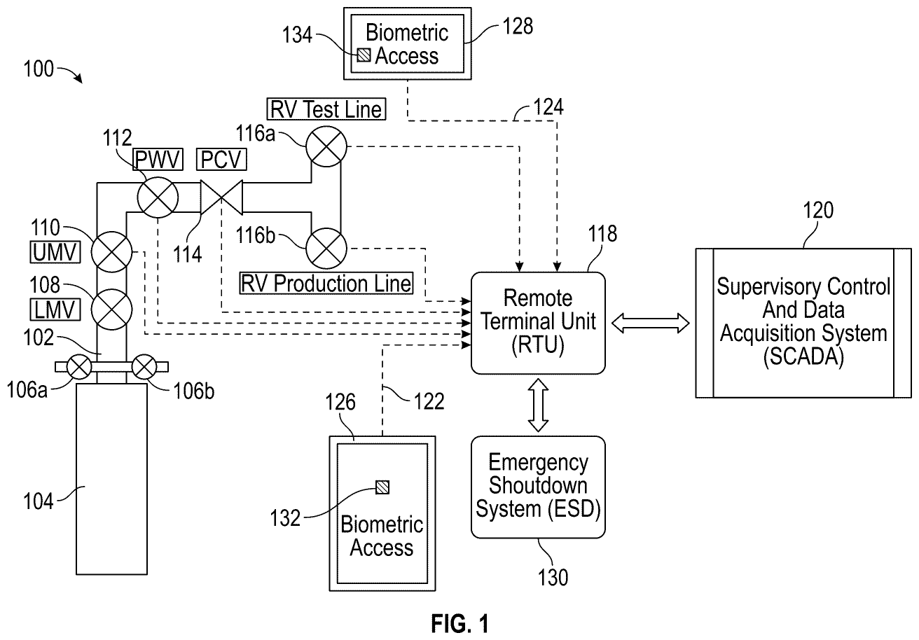

In the following description of FIGS. 1-4, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a passive soil gas sample system” includes reference to one or more of such systems.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In one aspect, embodiments disclosed relate to a system for biometric access control in the oil and gas industry. In one or more embodiments, the system employs multi-modal biometric authentication. In one or more embodiments, the multi-modal biometric authentication combines facial recognition with fingerprint or finger vein recognition. In one or more embodiments, the system integrates with existing security elements, such as surveillance cameras, door locks, and alarm notifications. In one or more embodiments, the system is integrated with a supervisory control and data acquisition (SCADA) unit, ensuring real-time data transfer to operation and security personnel for immediate response and action.

The systems and methods described herein integrate multi-modal biometric access control directly into the operational valves of oil and gas wells, offering a unique solution not reflected in existing technologies. Biometric authentication significantly reduces the risk of unauthorized access, as biometric data is much harder to duplicate or transfer than physical keys or passwords. By employing advanced multi-modal biometric authentication, the need for robust security in challenging environment conditions typical of oil and gas well sites is addressed. Furthermore, the systems and methods according to embodiments of this disclosure are designed to enhance operational efficiency without disrupting existing workflows, promoting higher user acceptance and operational integrity.

FIG. 1 is a diagram illustrating a system for biometric access in accordance with one or more embodiments of the present disclosure. FIG. 1 depicts an embodiment of a well site 100 having a wellhead 102 and associated components. The wellhead 102 may include a rigid structure installed at the “up-hole” end of a wellbore 104, at or near where the wellbore 104 terminates at the Earth's surface. The wellhead 102 may include structures (called “wellhead casing hanger” for casing and “tubing hanger” for production tubing) for supporting (or “hanging”) casing and production tubing extending into the wellbore 104. Production may flow through the wellhead 102, after exiting the wellbore 104. The wellhead 102 may include flow regulating devices that are operable to control the flow of substances into and out of the wellbore, such as valves.

FIG. 1 depicts a plurality of valves, including tubing casing annulus valves 106a and 106b. As understood herein in accordance with one or more embodiments, and as generally known in the oilfield arts, a tubing casing annulus (or “TCA”) may be defined between a casing in a wellbore (such as the wellbore 104 shown in FIG. 1) and tubing nested concentrically therewithin, such as production tubing. In one or more embodiments, the wellhead 102 includes a lower master valve 108, an upper master valve 110, a production wing valve 112, a production choke valve 114, and routing valves 116a and 116b, which control flow through a routing valve test line and a routing valve production line, respectively. The lower and upper master valves 108 and 110 may control flow from the wellbore 104. Further, the production wing valve 112 may be partially opened to partially restrict (or “throttle”) the flow of production from the wellbore 104. Alternatively, the production wing valve 112 may be fully closed to fully restrict (or “block”) the flow of production from the wellbore 104.

In one or more embodiments, the wellhead 102 comprises a choke assembly including hardware with functionality for opening and closing the fluid flow through pipes at the well site 100. The choke assembly may include a pipe manifold that may lower the pressure of fluid traversing the wellhead 102. As such, the choke assembly may include set of high pressure valves and at least two chokes, such as the production choke valve 114. The choke may be fixed or adjustable or a mix of both. As can be appreciated by one skilled in the art, the wellhead 102 may comprise any other valves, lines, and/or components customary to a typical wellhead that are not shown in the embodiment illustrated in FIG. 1.

In one or more embodiments, the biometric access system comprises a remote terminal unit 118 (or “RTU”). Each of the valves (or other components) of the wellhead 102 may be in wireless electronic communication with the remote terminal unit 118, as indicated by the dashed arrows. The remote terminal unit 118 is a microprocessor-controlled electronic device that may serve as an interface between the valves and other components (e.g., gauges) of the wellhead 102 and an existing supervisory control and data acquisition (“SCADA”) unit 120. The remote terminal unit 118 may monitor the functionality, or state, of the valves and other components of the wellhead 102 and transmit data to the SCADA unit 120. The remote terminal unit 118 may be located in a pipeline or at the surface of the well at any distance from the wellhead 102, provided that wireless communication is maintained between the remote terminal unit 118 and the connected valves/components of the wellhead 102.

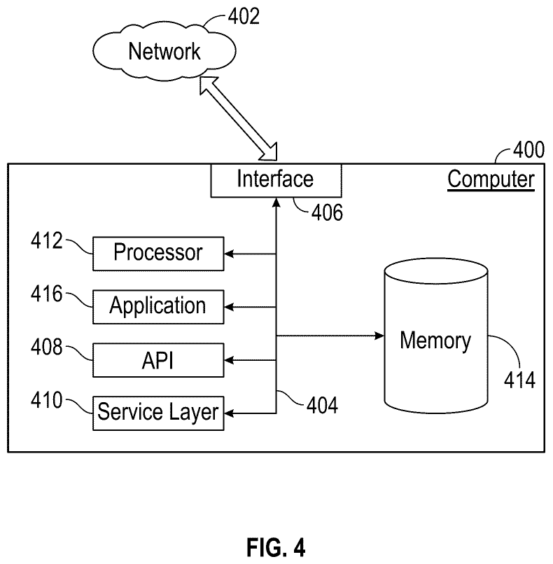

In accordance with one or more embodiments of the present disclosure, the SCADA unit 120 is used to remotely operate hydraulic valves (and/or other components of the wellhead 102) using wired and/or wireless data communication networks. The SCADA unit 120 may be a component of a well control system and may be comprised of computers, networked data communications, and graphical user interfaces for gathering and analyzing real time data. Specifically, the SCADA unit 120 may be used to monitor and control the well system. For example, various hydraulic valves, such as the production choke valve 114 and/or other surface/sub-surface valves may be remotely controlled using the SCADA unit 120 and the remote terminal unit 118. In particular, each hydraulic valve can be closed and/or opened in response to a control signal sent from, or otherwise activated by the SCADA unit 120. By manipulating valves (or other components) at the well site 100, one or more well parameters (e.g., flow, pressure) may be varied at the well site. In one or more embodiments of the invention, the SCADA unit 120 is implemented based on the computer 400 described in reference to FIG. 4 below.

In one or more embodiments, the remote terminal unit 118 receives biometric authentication data 122 and 124 from biometric access points 126 and 128, respectively. The biometric authentication data 122 and 124 may represent an approval or a denial of user access to the wellhead 102. Such biometric authentication data may be a Boolean value, a binary value, a score, a YES/NO value, or any other suitable approval or denial value. In response to data corresponding to authentication of the user and access approval, the remote terminal unit 118 may electronically communicate with the SCADA unit 120 via wireless communication. The SCADA unit 120 may then send a control signal to a door, lock, valve, or other component associated with the biometric access point to provide authorized access to a particular component (e.g., valve) or area (e.g., through a door) of the well site 100. Authorized access may be enabled through mechanical actuators connected with locks, doors, valves, and other components such that the mechanical actuators are controlled electronically via the SCADA unit 120, which responds to the authentication status. For instance, upon successful authentication, the biometric access system described herein may enable valve operation, which may include opening, closing or adjusting flowrates via mechanical actuators controlled by the SCADA unit 120 though the remote terminal unit 118. Non-limiting examples of mechanical actuators that may be implemented include pneumatic actuators (e.g., rack and pinion), hydraulic actuators (e.g., cylindrical tube and piston), and electric actuators (e.g., electric motor).

On the other hand, in response to data indicating that the user is not authorized to access a particular area or component of the well site, the remote terminal unit 118 may electronically communicate with an emergency shutdown system 130 that is configured to cause a responsive action to be performed. In one or more embodiments, the emergency shutdown system 130 is integrated with one or more surveillance cameras, door locks, and alarm systems within the well system via the remote terminal unit 118. Accordingly, the emergency shutdown system 130 and remote terminal unit 118 may produce control signals that cause one or more doors within the well system to automatically lock. In one or more embodiments, the emergency shutdown system 130 response includes the generation of auditory (e.g., alarm, automated voice commands) and/or visual alerts (e.g., flashing lights) at the well site 100. Furthermore, one or more surveillance cameras may be controlled in response to an indication of unauthorized access. For example, the remote terminal unit 118 may cause one or more surveillance cameras within the well site 100 to power on and/or move to survey the biometric access points and capture images of an unauthorized user.

As explained above, the well site 100 includes one or more biometric access points. In accordance with one or more embodiments of the present disclosure, there are at least two biometric access points 126 and 128 having different modalities. A first biometric access point 126 may be disposed at a door leading to a secure area of the well system. In this embodiment, the first biometric access point 126 comprises at least one first biometric sensor 132 proximate the door. The first biometric sensor 132 may be located on the door itself or a control panel near the door. Alternatively, the first biometric sensor 132 may be disposed on another component of the well site 100.

The first biometric sensor 132 is configured to digitally capture biometric data (e.g., face, finger, palm, iris). For facial recognition, the first biometric sensor 132 may be a camera. For fingerprint recognition, the first biometric sensor 132 may be a fingerprint pad/sensor. In one or more embodiments, the biometric data is an image of finger veins. Finger vein recognition involves the use of a finger vein recognition sensor comprising a near-infrared light-emitting diode (LED) and a monochrome charge-coupled device (CCD) camera. An image of the pattern of veins that appear in response to the near-infrared LED may be obtained. As can be appreciated by one skilled in the art, any other suitable type of biometric data may be obtained/collected including, but not limited to, voice, DNA, retina, hand geometry, and digital signature. Moreover, any suitable type of sensor (or sensors) for obtaining/collecting the biometric data may be implemented, including a voice recognition sensor, a palm vein sensor, a retina sensor, and a DNA sensor. Each type of biometric data obtained from a user may be compared to a database of previously stored biometric data collected from authenticated users in order to authenticate the user providing the biometric data at a given biometric access point.

As shown in FIG. 1, the biometric access system may include a second biometric access point 128. The second biometric access point 128 comprises a second biometric sensor 134. In one or more embodiments, the second biometric sensor 134 is located directly on a valve, or near a valve, that an authorized user wishes to access. For instance, the second biometric sensor 134 may be located on an electronic control panel near a given valve. The second biometric sensor 134 may obtain any type of biometric data, such as face, fingerprint, finger vein, palm, and iris, as described above for the first biometric sensor 132.

According to one or more embodiments of the present disclosure, the first biometric sensor 132 and the second biometric sensor 134 are different sensor types and provide distinct access to the well site 100. For instance, the first biometric sensor 132 at the first biometric access point 126 may be a fingerprint/finger vein sensor disposed on or near a door that requires authorization for access to at least one area of a well site 100. The fingerprint/finger vein data is transmitted to the remote terminal unit 118, which may determine whether there is a biometric data match in the database. If a biometric data match is made, the SCADA unit 120 may transmit one or more commands to one or more mechanical actuators associated with the designated door that are configured to unlock/open the door, providing access to the authenticated user.

Once a user has been authenticated at the first biometric access point 126, the user may then be required to be authenticated at the second biometric access point 128 in order to initiate an operational action (e.g., open/close valve) at the wellhead. In this embodiment, the second biometric access point 128 is a critical access point. In one or more embodiments, the second biometric sensor 134 is a camera for facial recognition. In one or more embodiments, the second biometric sensor 134 is located directly on a designated valve (e.g., production wing valve 112), such as on a valve handle. Biometric sensors may also be located on a production choke, valve body, safety relief valves, pipelines, junction points, manifold, chemical injection points, storage tanks, and flow meters, or any other well component that may benefit from access control. As can be appreciated by one skilled in the art, the second biometric sensor 134 may also be disposed on a door, control panel, or any other component of the well site 100 that requires authorized access.

In response to a biometric match between the user's biometric data and data stored in the database, the SCADA unit 120 may transmit one or more commands to one or more mechanical actuators associated with the designated valve for opening, closing or adjusting a flowrate of the designated valve. Alternatively, the designated valve may be secured behind a panel door, and a command from the SCADA unit 120 may cause the panel door to unlock and/or open, providing access to the user for manual adjustment of the designated valve. In one or more embodiments, the first biometric sensor 132 is a camera for facial recognition and the more critical second biometric sensor 134 is a fingerprint/finger vein detection sensor. As can be appreciated by one skilled in the art, the critical biometric access point and associated biometric sensor may be a third, fourth, or any number of access points and biometric sensors beyond a first access point and biometric sensor.

In accordance with one or more embodiments of the present disclosure, each critical component in a well system, such as lower master valve 108, upper master valve 110, production wing valve 112, production choke valve 114, routing valves 116a and 116b, and tubing casing annulus valves 106a and 106b, has its own biometric access point and biometric sensor in order to ensure that access and operation permissions are granular and specific to each component's operational needs. Therefore, any number of biometric sensors is possible depending on the number of components that require secure access. The biometric sensors may be strategically placed anywhere operator interaction is required to operate or monitor the component (e.g., valve, door), thereby ensuring that operators must authenticate before any physical interaction with equipment.

Embodiments disclosed in FIG. 1 present a cutting-edge integrated system, designed to enhance the security and operational efficiency of the offshore platforms and onshore wellsite in the oil and gas industry. The system of FIG. 1 is seamlessly incorporated into both success mechanisms of offshore platforms and operational control of wells, including master, wing, crown and choke valves. The integrated system of FIG. 1 elevates security protocols beyond traditional methods by employing a sophisticated multi-biometric authentication strategy that combines facial recognition with fingerprint or finger vein recognition. This dual authentication approach ensures a higher level of security and accuracy.

Further extending its security capabilities, the system of FIG. 1 integrates with existing security cameras, door locks, and alarm notifications, forming a holistic access control solution. Central to its operation is the integration with the supervisory control and data acquisition system (SCADA) 120, ensuring real-time data transfer to operation and security personnel for immediate response and action.

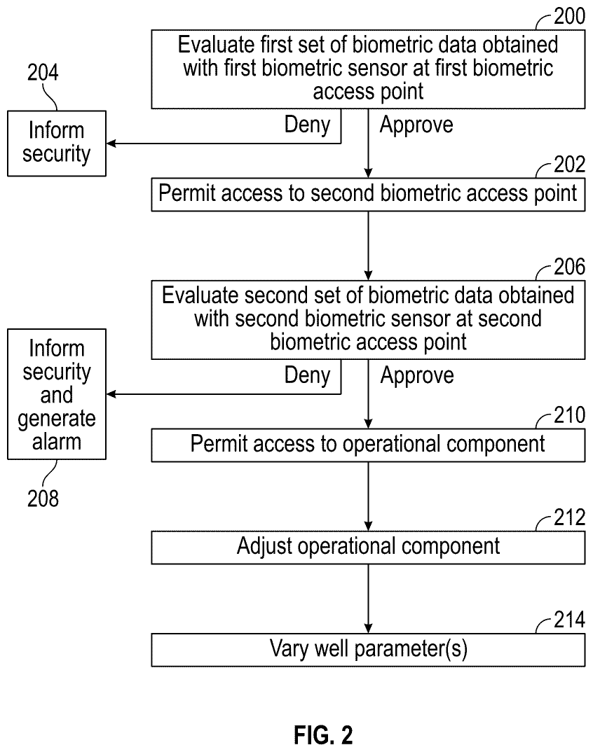

FIG. 2 is a flow diagram depicting an embodiment of the method for biometric access control described herein. In a first block 200, a first set of biometric data is evaluated. The first set of biometric data is obtained with a first biometric sensor at a first biometric access point. Based on a comparison between the first set of biometric data and stored data corresponding to an authorized user, access to the first biometric access point is either approved or denied. In response to an approval, access to a second biometric access point is permitted in block 202. In response to denied access, security is informed in block 204 and the process ends. In block 206, a second set of biometric data is evaluated. The second set of biometric data is obtained with a second biometric sensor at a second biometric access point. Based on a comparison between the second set of biometric data and stored data corresponding to an authorized user, access to the second biometric access point is either approved or denied. In response to access being denied, security is informed and an alarm is generated in block 208, and the process ends. The alarm may be any type of alert, such as an audio alert, a visual alert, a silent alarm that notifies security, or any other suitable combination thereof. In response to an approval, access to at least one operational well component is permitted in block 210. In block 212, the operational well component is adjusted. For instance, when the operational well component is a valve, the valve may be opened or closed in response to authentication of the user in order to regulate flow through the valve.

In one or more embodiments, the operational well component is, for example, a chemical injection pump. Access to a chemical injection pump may be controlled using the biometric access control system described herein. Chemical injection pumps are used to inject various chemicals (e.g., corrosion inhibitors, defoamers, detergents, methanol, emulsifiers, de-emulsifiers) into the wellbore or pipeline to enhance production efficiency, protect equipment, and ensure quality of oil and gas being produced. The pump injection rate and injection pressure may be adjusted (e.g., activate pump, adjust settings) in response to authentication of the user via one or more mechanical actuators connected with the chemical injection pump. In one or more embodiments, in this example scenario, a biometric sensor is placed directly on the chemical injection pump. The user/operator may gain operational control once the user's biometric data is authenticated. Real-time monitoring of operating procedures may be performed to ensure safety protocols for chemical handling are conducted according to company procedures and policies. Further, the system described herein provides documentation and compliance for each time the chemical injection pump (or other well component) is brought into service.

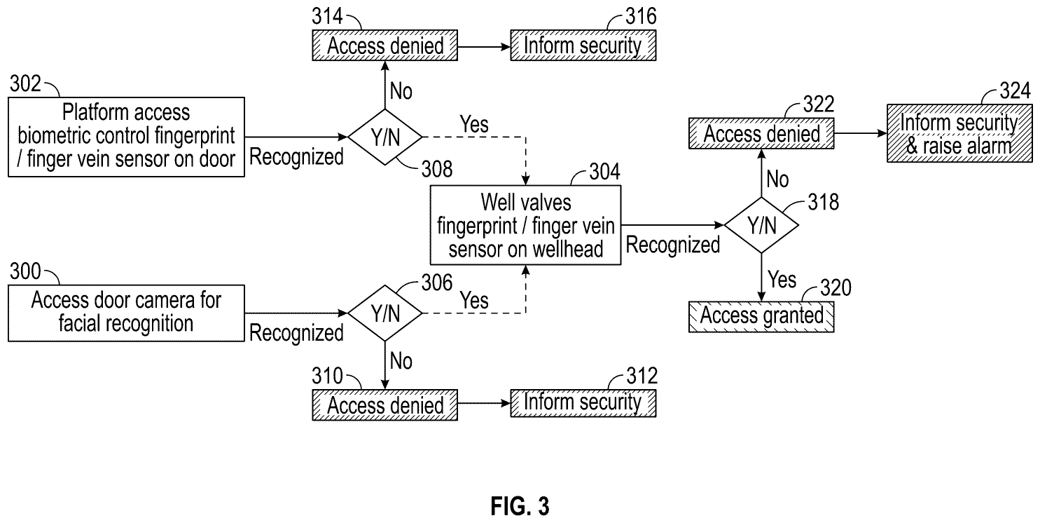

FIG. 3 depicts an example embodiment of the method for biometric access control according to the present disclosure. In this example embodiment, there are three biometric access points 300, 302, and 304. The first biometric access point 300 is an access door associated with a camera used for facial recognition. The second biometric access point 302 provides access to a platform at the well site via a fingerprint/finger vein sensor on a door. For each of the first biometric access point 300 and the second biometric access point 302, an authentication decision is made in blocks 306 and 308, respectively, based on evaluating biometric data obtained at each biometric access point.

In block 306, an authentication decision regarding facial recognition is made for the first biometric access point 300. In other words, block 306 includes determining whether a facial image, obtained by the camera, of the individual attempting to gain access correlates with a stored image of an authenticated user. The remote terminal unit and SCADA unit may be involved in the determination and relaying of signals related to the authentication decision. In response to the image of the individual not being authenticated, access is denied in block 310. The access door may remain locked/closed, and security personnel may be informed via, for instance, a visual or auditory alert, that an unauthorized individual is attempting to gain access in block 312. For instance, a notification may be presented on a display screen (e.g., smartphone display, computer monitor).

Similar to the first biometric access point 300, an authentication decision may be made in block 308 at the second biometric access point 302. In block 308, an authentication decision may be determining whether the fingerprint/finger vein of the individual attempting to gain access matches fingerprint/finger vein data corresponding to an authenticated user. As with the first biometric access point 300, the remote terminal unit and SCADA unit may be involved in the determination and relaying of signals related to the authentication decision. In response to the fingerprint/finger vein not being recognized as an authorized user, access is denied in block 314. The access door may remain locked/closed, and security personnel may be informed via, for instance, a visual or auditory alert, that an unauthorized individual is attempting to gain access in block 316. For instance, a notification may be presented on a display screen (e.g., smartphone display, computer monitor).

In response to the user being recognized as an authorized user, at either, or both, of the first biometric access point 300 and the second biometric access point 302, the access door at a respective access point may be unlocked/opened, allowing the user entry through the access door and to the third biometric access point 304. In one or more embodiments, the third biometric access point 304 comprises a fingerprint/finger vein sensor disposed on a well valve of a wellhead. In block 318, an authentication decision may be made to determine whether the fingerprint/finger vein of the individual attempting to gain access matches fingerprint/finger vein data corresponding to an authenticated user. As with the other biometric access points, the remote terminal unit and SCADA unit may be involved in the determination and relaying of signals related to the authentication decision.

In response to the user being recognized, access to operation of the well valve having the fingerprint/finger vein sensor is granted in block 320. The user may then proceed to take any necessary actions to adjust and/or control the well valve. In response to the user's fingerprint/finger vein not being authorized, access is denied in block 322. In one or more embodiments, access denial at the third biometric access point 304 may be considered a more significant event because the user has made it past at least one other access point. Therefore, in addition to security being informed, an alarm may be raised at the well site.

FIG. 3 is provided only as an example of the types and arrangement of biometric access points and biometric sensors at a well site and is not intended to limit the invention to any specific embodiment. Accordingly, embodiments of the invention should not be considered limited to the specific arrangements of modules and/or elements shown in FIG. 3. As can be appreciated by one skilled in the art, there may be any number of biometric access points within the well site. Additionally, the biometric sensors may be located at any suitable location at an access point, such as on a door, lock, wall, control panel, or well component (e.g., valve). Furthermore, any type of biometric sensor may be implemented in the systems and methods described herein, provided that the biometric sensor captures biometric data of an individual attempting to gain access to the well site. For instance, a first biometric access point, such as a door, may include fingerprint recognition technology. Fingerprint sensors (i.e., scanners) are quick and efficient, making them suitable for initial access checks at first biometric access points where speed is essential. The subsequent biometric sensor may use finger vein recognition. Finger vein recognition technology is suitable for a well valve access point, or other critical access point, which requires a higher level of security. Using different types of biometric sensors at different access points of a well site enhances security layers in addition to reducing the rate of false acceptances or rejections, thereby increasing overall system reliability.

FIG. 4 depicts a block diagram of a computer 400 used to provide computational functionalities associated with described analysis, methods, functions, processes, flows, and procedures as described in this disclosure, according to one or more embodiments. The illustrated computer 400 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 400 may include an input device, such as a keypad, keyboard, touch screen, or other device that can accept user information, and an output device that conveys information associated with the operation of the computer 400, including digital data, visual, or audio information (or a combination of information), or a GUI.

The computer 400 can serve in a role as a client, network component, a server, a database or other persistency, or any other component (or a combination of roles) of a computer system for performing the subject matter described in the instant disclosure. The illustrated computer 400 is communicably coupled with a network 402. In some implementations, one or more components of the computer 400 may be configured to operate within environments, including cloud-computing-based, local, global, or other environment (or a combination of environments). For instance, the computer 400 may be utilized as a component of the remote terminal unit and/or SCADA unit to analyze the biometric data received by the biometric sensors.

At a high level, the computer 400 is an electronic computing device operable to receive, transmit, process, store, or manage data and information associated with the described subject matter. According to some implementations, the computer 400 may also include or be communicably coupled with an application server, e-mail server, web server, caching server, streaming data server, business intelligence (BI) server, or other server (or a combination of servers).

The computer 400 can receive requests over network 402 from a client application (for example, executing on another computer 400) and responding to the received requests by processing the said requests in an appropriate software application. In addition, requests may also be sent to the computer 400 from internal users (for example, from a command console or by other appropriate access method), external or third-parties, other automated applications, as well as any other appropriate entities, individuals, systems, or computers.

Each of the components of the computer 400 can communicate using a system bus 404. In some implementations, any or all of the components of the computer 400, both hardware or software (or a combination of hardware and software), may interface with each other or an interface 406 (or a combination of both) over the system bus 404 using an application programming interface (API) 408 or a service layer 410 (or a combination of the API 408 and service layer 410). The API 408 may include specifications for routines, data structures, and object classes. The API 408 may be either computer-language independent or dependent and refer to a complete interface, a single function, or even a set of APIs. The service layer 410 provides software services to the computer 400 or other components (whether or not illustrated) that are communicably coupled to the computer 400. The functionality of the computer 400 may be accessible for all service consumers using this service layer. Software services, such as those provided by the service layer 410, provide reusable, defined business functionalities through a defined interface. For example, the interface may be software written in JAVA, C++, or other suitable language providing data in extensible markup language (XML) format or another suitable format. While illustrated as an integrated component of the computer 400, alternative implementations may illustrate the API 408 or the service layer 410 as stand-alone components in relation to other components of the computer 400 or other components (whether or not illustrated) that are communicably coupled to the computer 400. Moreover, any or all parts of the API 408 or the service layer 410 may be implemented as child or sub-modules of another software module, enterprise application, or hardware module without departing from the scope of this disclosure.

The computer 400 includes an interface 406. Although illustrated as a single interface 406 in FIG. 4, two or more interfaces 406 may be used according to particular needs, desires, or particular implementations of the computer 400. The interface 406 is used by the computer 400 for communicating with other systems in a distributed environment that are connected to the network 402. Generally, the interface 406 includes logic encoded in software or hardware (or a combination of software and hardware) and operable to communicate with the network 402. More specifically, the interface 406 may include software supporting one or more communication protocols associated with communications such that the network 402 or interface's hardware is operable to communicate physical signals within and outside of the illustrated computer 400.

The computer 400 includes at least one computer processor 412. Although illustrated as a single computer processor 412 in FIG. 4, two or more processors may be used according to particular needs, desires, or particular implementations of the computer 400. Generally, the computer processor 412 executes instructions and manipulates data to perform the operations of the computer 400 and any algorithms, methods, functions, processes, flows, and procedures as described in the instant disclosure. In one or more embodiments, the computer 400 analyzes the biometric data and compares it to data stored in a memory or database that includes biometric data from authorized users.

The computer 400 also includes a memory 414 that holds data for the computer 400 or other components (or a combination of both) that can be connected to the network 402. For example, memory 414 can be a database storing data consistent with this disclosure. Although illustrated as a single memory 414 in FIG. 4, two or more memories may be used according to particular needs, desires, or particular implementations of the computer 400 and the described functionality. While memory 414 is illustrated as an integral component of the computer 400, in alternative implementations, memory 414 can be external to the computer 400.

The application 416 is an algorithmic software engine providing functionality according to particular needs, desires, or particular implementations of the computer 400, particularly with respect to functionality described in this disclosure. For example, the application 416 can serve as one or more components, modules, applications, etc. Further, although illustrated as a single application 416, the application 416 may be implemented as multiple applications 416 on the computer 400. In addition, although illustrated as integral to the computer 400, in alternative implementations, the application 416 can be external to the computer 400.

There may be any number of computers 400 associated with, or external to, a computer system containing computer 400, wherein each computer 400 communicates over network 402. Further, the term “client,” “user,” and other appropriate terminology may be used interchangeably as appropriate without departing from the scope of this disclosure. Moreover, this disclosure contemplates that many users may use one computer 400, or that one user may use multiple computers 400.

In one or more embodiments, a display device (e.g., display screen, computer monitor) may be coupled with the computer 400, wherein the display device is configured to display video and/or graphics. The display device may include a cathode ray tube (“CRT”), liquid crystal display (“LCD”), field emission display (“FED”), plasma display, or any other display device suitable for displaying video and/or graphic images and alphanumeric characters recognizable to a user. For instance, a display device may be positioned near one or more biometric access points to provide instructions to a user regarding how to use a particular biometric sensor. Further, a display device may be utilized to inform security personnel of an unauthorized user attempting to access the well site.

In some embodiments, the computer 400 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

The invention according to one or more embodiments of the present disclosure provides an integrated system designed to enhance the security and operational efficiency of offshore platforms and onshore well sites in the oil and gas industry. Only authorized personnel may be provided access to operating components used to adjust, or vary, critical well parameters, thereby integrating security with operational management. Non-limiting examples of well parameters that may be controlled (i.e., varied, adjusted) include pressure, flow rate, temperature, chemical dosage, choke valve settings, and production rate. Direct control over well parameters by only authorized personnel prevents accidental or intentional operational disruptions.

The invention described herein surpasses existing methods with its innovative integration of biometric access directly into an oil and gas operational infrastructure, providing enhanced security through multi-modal biometric authentication, such as facial, finger veins, or fingerprint recognition, that is more accurate and much difficult to bypass. The system's real-time, remote monitoring capabilities via SCADA offers operational oversight, allowing rapid response to any issues.

The system according to one or more embodiments of this disclosure may be seamlessly incorporated into both success mechanisms of offshore platforms and operational access to well valves, including master, wing, crown, and choke valves. Operational access may be considered access that allows for adjustment, opening, closing, turning on, turning off, or any other suitable manner by which a user may control or operate a well component. Security protocols are elevated beyond traditional methods by employing a multi-biometric authentication strategy that combines facial recognition with fingerprint or finger vein recognition. The dual authentication approach ensures a higher level of security and accuracy.

Furthermore, embodiments described herein enable uninterrupted operations while maintaining strict security controls, ensuring that safety does not come at the expense of productivity. The system is designed to be compatible with newly introduced monitoring and control systems, offering a flexible solution that can adapt to future technological advancements. Moreover, the system's capabilities extend to synchronizing with existing security infrastructure, including cameras, door locks, and alarm systems, establishing a robust, all-encompassing access control network. Integration with a SCADA unit, enabling real-time data transmission directly to operations and security personnel, ensures that every data point and security alert is instantly accessible, facilitating swift decision-making and action.

Through tight control access to critical operational components, the system according to one or more embodiments of the present disclosure deters any potential vandalism, theft, or other improper action on the wells. Additionally, the invention addresses the unique security challenges faced by the harsh environmental conditions common in oil and gas production operations on offshore platforms and onshore well sites, such as extreme temperatures, humidity, dust, and risk of fire and explosion. For example, the components of the system for biometric access control may include ruggedized hardware made from materials selected for enhanced durability and operational integrity. The components may include explosion proof enclosures, advanced environmental sealing, UV resistance, and/or anti-corrosive treatments.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for biometric access control at a well site, the method comprising:
evaluating a first set of biometric data obtained with a first biometric sensor, the first biometric sensor associated with a first biometric access point at the well site;
in response to authenticating a user at the first biometric access point, permitting the user access to a second biometric access point at the well site;
evaluating a second set of biometric data obtained with a second biometric sensor, the second biometric sensor associated with the second biometric access point controlling access to at least one operational component at the well site;
in response to authentication of the user at the second biometric access point, permitting the user operational access to the at least one operational component at the well site;
adjusting the at least one operational component; and
in response to the adjusting, varying one or more well parameters at the well site.

2. The method of claim 1, wherein authenticating the user at the first biometric access point comprises:
capturing an image of the user; and
determining whether the image correlates with a stored image of an authenticated user.

3. The method of claim 1, wherein authenticating the user at the second biometric access point comprises:
obtaining an image comprising a pattern of finger veins of the user; and
determining whether the pattern of finger veins correlates with a pattern of finger veins in a stored image of an authenticated user.

4. The method of claim 1, wherein providing access to the second biometric access point comprises causing an access door to unlock.

5. The method of claim 1, further comprising informing security personnel in response to the user not being authenticated at the first biometric access point.

6. The method of claim 1, further comprising informing security personnel and generating an alarm in response to the user not being authenticated at the second biometric access point.

7. The method of claim 1, wherein providing operational access to the at least one operational component comprises electronically controlling a mechanical actuator connected with the at least one operational component.

8. The method of claim 7, wherein the at least one operational component is a well valve, and the method further comprises opening or closing the well valve via the mechanical actuator.

9. A system for biometric access control at a well site, the system comprising:
a first biometric sensor configured for obtaining a first set of biometric data from a user,
wherein the first biometric sensor is associated with a first biometric access point at the well site, the first biometric access point controlling access to a second biometric access point at the well site;
a second biometric sensor configured for obtaining a second set of biometric data from the user,
wherein the second biometric sensor is associated with the second biometric access point, the second biometric access point controlling access to at least one operational component at the well site; and
a mechanical actuator connected with the at least one operational component at the well site, the mechanical actuator configured for adjusting the at least one operational component to vary one or more well parameters at the well site.

10. The system of claim 9, further comprising a remote terminal unit and a supervisory control and data acquisition unit configured for wirelessly controlling the mechanical actuator in response to the user being authenticated at the second biometric access point.

11. The system of claim 9, wherein the first biometric sensor is a camera, and the second biometric sensor is a fingerprint recognition sensor.

12. The system of claim 9, wherein the first biometric sensor is a camera, and the second biometric sensor is a finger vein recognition sensor.

13. The system of claim 9, wherein the second biometric sensor is disposed directly on the at least one operational component.

14. The system of claim 9, wherein the at least one operational component is a well valve.

15. The system of claim 14, wherein the well valve is selected from the group consisting of a master valve, a wing valve, a crown valve, and a choke valve.

16. The system of claim 14, wherein the first biometric sensor is disposed on a door, and the second biometric sensor is disposed on a handle of the well valve.

17. The system of claim 10, further comprising an emergency shutdown unit integrated with at least one of a surveillance camera, a door lock, and an alarm via the remote terminal unit.

18. The system of claim 12, wherein the finger vein recognition sensor comprises a near-infrared light-emitting diode and a monochrome charge-coupled device camera.

19. The system of claim 9, wherein the first biometric sensor and the second biometric sensor are different types of biometric sensors configured to collect different types of biometric data.

20. The system of claim 9, wherein the first biometric sensor and the second biometric sensor are integrated with a supervisory control and data acquisition unit at the well site to facilitate real-time monitoring of the first and second biometric access points and direct, real-time data transmission to personnel.
